(19) United States
(12) Patent Application Publication
(10) Pub. No.: US 2008/0003032 A1
(43) Pub. Date: Jan. 3, 2008

(54) Double-sided image forming apparatus

(75) Inventors: Ken Nonaka, Tokyo (JP); Atsushi Arai, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/785,357

(22) Filed: Apr. 17, 2007

(30) Foreign Application Priority Data
Jun. 30, 2006 (JP) JP2006-181114
Feb. 27, 2007 (JP) JP2007-046878

(51) Int. Cl. G03G 15/00

(52) U.S. Cl. 399/389

(57) ABSTRACT

A double-sided image forming apparatus, including: an image forming section; a sheet supplying section, which supplies a sheet to the image forming section, including paired registration rollers which convey the sheet supplied from the sheet supplying section to the image forming section; a flipping conveyance route which conveys the sheet carrying an image formed by the image forming section on a front side, and which flips the sheet to re-supply to the paired registration rollers; and a control section which controls to change a length of the flipping conveyance route, and controls to convey the sheet based on a size of the sheet.

### CROSS REFERENCE TO RELATED APPLICATION

This application is based on Japanese Patent Application No. JP2006-181114 filed on Jun. 30, 2006, and JP2007-046878 filed on Feb. 27, 2007 with the Japanese Patient Office, the entire content of which is hereby incorporated by reference.

### TECHNICAL FIELD

The present invention relates to an advancement technology of image forming efficiency in an image forming apparatus which forms an image on double sides of a sheet.

### BACKGROUND OF THE INVENTION

Generally, in the double-sided image forming apparatus, the image is firstly formed on a front side of a recording sheet at an image forming section, after which the recording sheet is reversed and returned again to the image forming section, where another image is then formed on a reverse side of the recording sheet. Via the above procedure, the double-sided image formation is completed.

However, in the above image forming procedure, the image forming efficiency is not necessarily high, leading to efforts to increase the efficiency by improving control of the re-supplying section of the recording sheet to return to the image forming section for the reverse side image formation.

At the same time, in Unexamined Japanese Patent Application Publication No. 5-330,172, in order to efficiently and effectively convey the recording sheet, based on the booklet pagination copy operation, the execution state of image formation, the type of recording sheet, and the size of recording sheet, a first path whose entire length is larger than the length of the recording sheet, and a second path whose entire length is smaller than the length of the recording sheet are provided, whereby the first path or the second path is selected for image formation. However, the above patent document does not disclose image forming efficiency of double-sided image formation.

In the double-sided image forming apparatus of an electro-photographic image forming apparatus, concerning the procedure of double-sided image formation, after the image is formed on one side of the recording sheet at the image forming section, the recording sheet is fed to the sheet re-supplying section to be reversed and then returned to the image forming section, after which an image is formed on the reverse side of the recording sheet.

In this double-sided image forming procedure, a circulation conveyance route is established based on a standard mode as the most frequently used sheet size, such as long edge conveyance of an A-4 size sheet. Accordingly, the productivity rate of printed sheets becomes greatest in the case of long edge conveyance of the A-4 size sheet. The long edge conveyance means that the recording sheet is conveyed while the short edge of the recording sheet is parallel to its conveyance direction.

However, in the above method, when sheet conveyance other than long edge conveyance of A-4 size sheets is conducted for double-sided image formation, productivity of prints is actually decreased, which will now be detailed while referring to FIGS. 1(a) and 1(b).

FIG. 1(a) shows timing of double-sided image formation in the case of the long edge conveyance of the A-4 size sheet. FIG. 1(b) shows a model of timing in which the double-sided image formation in the case of the short edge conveyance of an A-4 sheet is conducted. In FIGS. 1(a) and 1(b), image formation is conducted on five individual recording sheets.

In each figure, the horizontal direction shows time. Solid lined frames represent the front side image formation, while dashed lined frames represent timing which is equivalent to image formation, though no actual image formation is conducted. Hatched frames represents reversed side image formation, while the number in each frame represents the order of the conveyed recording sheet, and the number of the conveyed sheet.

In FIG. 1(a), firstly image formation is conducted on the front side of sheet 1, after blank time H1, which is a time interval for conveying a single sheet, is secured, image formation is conducted on the front side of sheet 2. Next, after blank time H2, which is a time interval for conveying a single sheet, is secured, image formation is conducted on the front side of sheet 3.

Next, image formation is conducted on the reversed side of sheet 1. Following that, image formation is conducted on the front side of sheet 4. Next, after image formation is conducted on the reverse side of sheet 2, image formation is conducted on the front side of sheet 5, and image formation is conducted on the reverse side of sheet 3.

Next, blank time H3 which is a time interval for conveying a single sheet, is secured. Then image formation is conducted on the reverse side of sheet 4. Further, after blank time H4, which is a time interval for conveying a single sheet, is secured, image formation is conducted on the reverse side of sheet 5.

In double-sided image forming apparatus in FIG. 1, the length of the circulation conveyance route is designed so as to accommodate up to five A-4 size sheets for the long edge conveyance. At both the beginning and ending sections of double-sided image formation, blank timings are provided respectively. Interval time D between each recording sheet is established to be as short as possible, so that the apparatus can work optimally. The circulation conveyance route will be detailed later.

The most effective image formation is conducted when interval time D between each recording sheet is established to be an optimum value during image formation, which represents the image formation with a 100% productivity rate.

FIGS. 1(a) and 1(b) show the case in which five recording sheets are accommodated in the circulation conveyance route. Accordingly, the circulation time for the recording sheets in the circulation conveyance route becomes the total time corresponding to the necessary time for image formation on five sheets.

Image formation with the 100% productivity rate in FIG. 1(a) is expressed by formula T=n (L+D). Where, “T” represents necessary time in which a recording sheet circulates in the circulation conveyance route (hereinafter referred to as “a circulation time”). “L” represents the time interval corresponding to the length of the recording sheet in the conveyance direction. “D” represents the time interval between the end of the preceding sheet and the top of the trailing sheet. Further, “n” represents the total number of recording sheets which are accommodated in the circulation conveyance route.

The condition of sheet supplying timing in double-sided image formation is expressed by formula T≧n(L+D).

If the above condition is not satisfied, time interval D becomes shorter than a limited interval, that is, the sheets are not accommodated in the circulation conveyance route. In such negative case, the number of accommodated sheets is reduced as shown by formula T≧(n−1) (L+D), and thereby the above condition is obtained so that the sheets to be supplied are controlled.

Under the condition that the double-sided image forming apparatus performs 100% production rate of the long edge conveyance as shown in FIG. 1(a), a timing chart for short edge conveyance of A-4 size sheets is shown in FIG. 1(b). In addition, “short edge conveyance” means that the recording sheet is conveyed while the long edge of the recording sheet is parallel to its conveyance direction.

Firstly image formation is conducted on the front side of sheet 1, after blank time H1 as a single sheet is secured, image formation is conducted on the front side of sheet 2. Next, image formation is conducted on the reverse side of sheet 1.

In this case, between image formation of the front side of sheet 2 and that of the reverse side of sheet 1, time interval E is generated which is greater than optimum time interval D.

Time interval E is set due to the following reason.

In FIG. 1(b), circulation time T, in which a single sheet circulates in the circulation conveyance route, is shown by formula T<(4L+4D). Accordingly, double-sided image formation is conducted by setting the conveyance condition satisfying T>(3L+3D).

Further, between image formation on the front side of sheet 2 and that of the reversed side of sheet 1, time interval E is generated which is less than (L+D), but definitely greater than optimum time interval D. Due to this, productivity of prints is reduced.

Still further, circulation time T2 of FIG. 1(b) is slightly greater than circulation time T1 of FIG. 1(a). Because the length of recording sheet becomes longer, and thereby the conveyance time becomes greater in flipping conveyance route 82. When referring to FIG. 2, recording sheet P enters flipping conveyance route 82 at position 82A, after which recording sheet P is switched back to position 82A. The time interval of the above flipping conveyance is proportional to the length of recording sheet P. Accordingly circulation time T depends upon the length of recording sheet P.

Further, at the terminal stage of double-sided image formation, that is, in the condition that the double-sided image forming apparatus completes supply of sheets from sheet supplying section 6, and supplies sheets P only from re-supplying route 84, it takes extra time for securing blank time H3 in FIG. 1(a), which results in a lowered production rate.

### SUMMARY OF THE INVENTION

An object of the present invention is to provide a double-sided image forming apparatus which can conduct double-sided image formation with high production efficiency, by controlling poor efficiency generated by the reduced production rate, and further by controlling the extra time, in conventional double-sided image formation as described above.

The object of the present invention will be attained by an invention described below.

In a double-sided image forming apparatus, including an image forming section; a sheet supplying section, which supplies a sheet to the image forming section, including paired registration rollers which convey the sheet supplied from the sheet supplying section to the image forming section; and a circulation conveyance route which conveys the sheet carrying an image formed by the image forming section on a front side, and which flips the sheet to re-supply to the paired registration rollers; the double-side image forming apparatus is characterized in that a control section changes a length of the circulation conveyance route, and controls to convey the sheet, based on a size of the sheet.

### BRIEF DESCRIPTION OF THE DRAWINGS

FIG. 1(a) is timing of long edge conveyance of A-4 size recording sheet, while FIG. 1(b) is timing of short edge conveyance of A-4 size recording sheet, in the double-sided image formation.

FIG. 2 shows the total schematic structure of an image forming apparatus which is a digital copying apparatus.

FIG. 3 shows an example of timing of the conveyance of recording sheets in the case of double-sided image formation of the embodiment of the present invention.

FIG. 4 shows a portion of a timing chart of double-sided image formation.

FIG. 5 is a block diagram of conveyance control of double-sided image formation, relating to embodiment 1.

FIG. 6 is an example of the shortest re-supplying route.

FIG. 7 is an example of the longest re-supplying rout.

FIG. 8 is a block diagram of conveyance control of double-sided image formation, relating to embodiment 2.

### DETAILED DESCRIPTION OF THE PREFERRED EMBODIMENTS

The embodiments of the present invention will now be detailed while referring to the drawings, but the present invention is not limited to the described embodiments.

### Embodiment 1

FIG. 2 shows the total structure of a double-sided image forming apparatus which is a digital copying apparatus.

In FIG. 2, numeral 1 represents an image forming section, which forms toner image on photo conductor 10 via electrostatic-charging, exposure and fixing procedures. Numeral 2 represents a transfer device, which transfers the toner image formed on photo-conductor 10 onto recording sheet P. Numeral 3 represents a fixing device, which heats and thereby fixes the toner image transferred onto recording sheet P.

Numeral 4 represents a switching gate, which switches to either eject recording sheet P onto exterior ejection tray 5 or to convey recording sheet P to sheet re-supplying section 8. Numeral 6 represents a sheet supplying section, which conveys sheet P one by one from sheet supplying tray 60 via paired sheet supplying rollers 61.

Numeral 7 represents a sheet supply conveyance section, which includes sheet supplying route 71, which is from sheet supply tray 60 to paired registration rollers 72, and paired registration rollers 72.

Numeral 8 is a sheet re-supplying section, which conveys sheet P to paired registration rollers 72, for reverse side image formation procedure of double-sided image formation. Sheet re-supplying section 8 includes branched conveyance route 81 which is branched from switching gate 4, flipping conveyance section 82 which flips sheet P, re-supplying route 83 which conveys the flipped sheet, sheet re-supplying routes 84 and 85 which are from switching member 86 to paired registration rollers 72, switching member 86 and solenoid 104 which drives switching member 86.

Sheet re-supplying route 84 forms a shorter route which is from sheet re-supplying section 8 to paired registration rollers 72, while sheet re-supplying route 85 forms a longer route which is from re-supplying section 8 to paired registration rollers 72. Sheet re-supplying routes 84 and 85 are selected by switching gate 86.

The operation of the image forming apparatus shown in FIG. 2 is detailed below.

In image forming section 1, a toner image is formed on photo-conductor 10, and paired registration rollers 72 convey recording sheet P synchronized with image formation in image forming section 1, whereby the toner image is transferred onto recording sheet P at a transfer position where transfer device 2 is mounted. The transferred toner image is fixed onto recording sheet P after passing through fixing device 3.

In single-sided image formation, recording sheet P is ejected to exterior ejection tray 5 after image fixing.

In double-sided image formation, after an image is transferred onto the front side of recording sheet P, recording sheet P passes through fixing device 3 and is conveyed to branched conveyance route 81 via switching gate 4.

Next, recording sheet P is flipped by flipping roller 92 at flipping conveyance section 82, after which flipped recording sheet P is conveyed back to paired registration rollers 72, via sheet re-supplying route 83, and either shorter re-supplying route 84 or longer re-supplying route 85.

By paired registration rollers 72 which works in synchronizing with reverse side image formation on image forming section 1, flipped recording sheet P is again conveyed to the transfer position, where another toner image is transferred onto the reverse side of recording sheet P, and that image is fixed via fixing device 3, and sheet P carrying the images on the double sides is finally ejected to exterior ejection tray 5.

As shown in FIG. 2, longer re-supplying route 85 flows together with sheet supplying route 71 originating from sheet supplying section 6, and continues to paired registration rollers 72.

Next, conveyance control of the recording sheet in the case of double-sided image forming procedure will now be detailed.

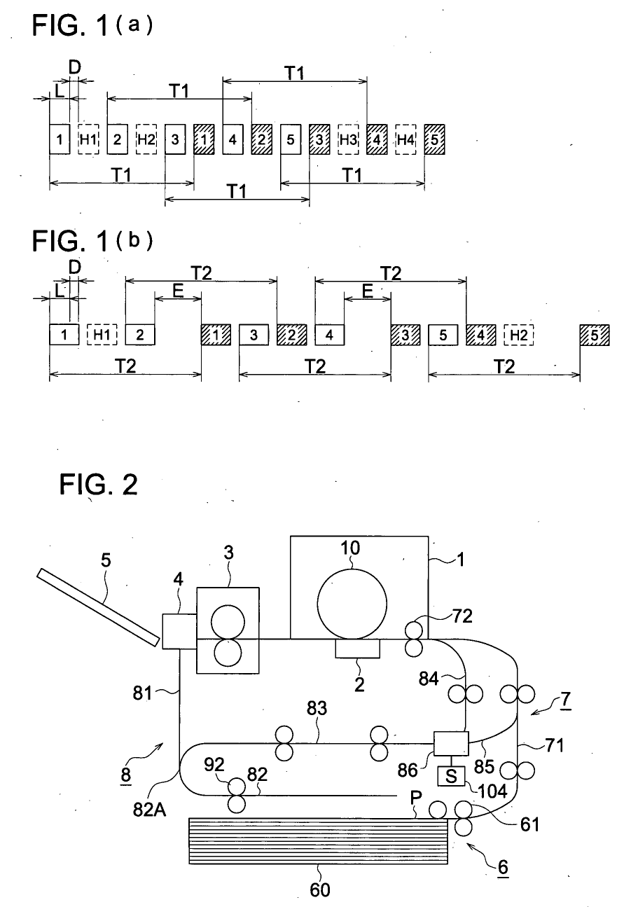

The double-sided image forming procedure of the long edge conveyance of A-4 size sheets is conducted via timing shown in FIG. 1(a).

In this case, re-supplying route 84 is selected, therefore the conveyance length is set shorter.

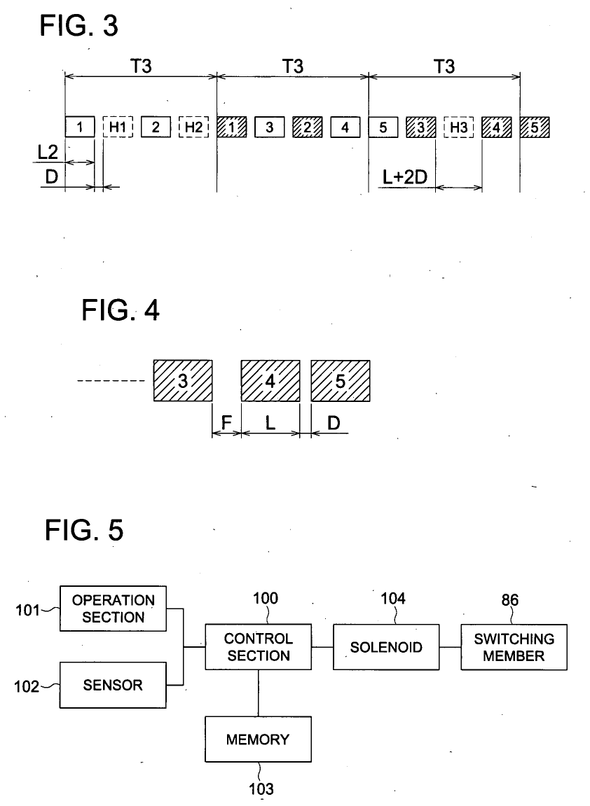

On the other hand, in the case of double-sided image formation for the short edge conveyance of A-4 size sheets, longer re-supplying route 85 is selected, and double-sided image formation is conducted by timing shown in FIG. 3. Switching gate 86 switches either the shorter or longer re-supplying route.

By selecting either shorter route 84 or longer route 85, the length of the circulation conveyance route can be changed.

“Circulation conveyance route” is the sheet supplying route for reverse side image formation, which starts from paired registration rollers 72, through fixing device 3, switching gate 4, branched conveyance route 81, flipping conveyance route 82, re-supplying route 83, and sheet re-supplying route 84 (or 85), terminating at paired registration rollers 72. Further, when the length of circulation conveyance route is calculated, the length of flipping conveyance route 82 is the length in the conveyance direction of a single recording sheet for each size.

As shown in FIG. 3, since the length of the circulation conveyance route is changed, a circulation time of a single sheet which is conveyed through the circulation conveyance route is changed from circulation time T1 for the long edge conveyance of A-4 size sheet, to circulation time T3, which is longer than circulation time T1.

Circulation time T3 is based on formula T3=4L+4D. Due to this, time interval E in FIG. 1(b) can be eliminated in FIG. 3, whereby image interval is reduced to optimum time interval D. That is, double-sided image formation can be conducted by 100% productivity.

When comparing FIG. 1(b) and FIG. 3, the total time for image forming procedure is shortened in FIG. 3, compared to the case of FIG. 1(b).

In FIG. 3, circulation time T is determined by formula T=n(L+D), which is determined so as to become 100% productivity. However, since there are various sizes of recording sheets, even when the length of the circulation conveyance route is changed, some cases happen where formula T=n(L+D) is not satisfied. In this case, that is, when formula T>n(L+D) is applied, value [T−n(L+D)] is reduced by the change of the length of the circulation conveyance route, which increases the productivity.

FIG. 4 shows that the conveyance time is reduced at the terminal stage of double-sided image formation during the short edge conveyance of A-4 size sheet. Further, FIG. 4 is a portion of the timing chart of double-sided image formation for five sheets, which is the same as FIG. 3.

At the terminal stage, that is, when image formation is conducted on the reversed sheets which are conveyed only through re-supplying route of the circulation conveyance route, and further, when the time interval corresponding to front side image formation becomes blank, the length of the circulation conveyance route can be shortened by being switched to re-supplying route 84.

In the total procedure of double-sided image formation in FIG. 3, longer re-supplying route 85 is typically selected. Consequently, the time interval between image formation on the reverse of sheet 3 and image formation on the reverse of sheet 4 becomes (L+2D).

On the other hand in FIG. 4, in the terminal stage of the double-sided image formation in which the sheets are not supplied from sheet supplying section 6, shorter re-supplying route 84 is selected, switched from longer re-supplying route 85.

Due to this switching, time interval F in FIG. 4, which is the time interval between image formation of the reverse of sheet 3 and image formation on the reverse of sheet 4, becomes shorter than (L+2D), whereby the total image forming time is reduced.

In addition, at the terminal stage of double-sided image formation, the sheet conveyance speed in the circulation conveyance route can be increased, whereby the image forming time is further shortened to improve the image forming efficiency.

As described above, at the terminal stage of the double-sided image formation, the circulation conveyance route can be set to be shorter so that the time of double-sided image formation procedure can be shortened, resulting in further improved image forming efficiency.

FIG. 5 is a block diagram of a conveyance control system which conducts the conveyance control shown in FIGS. 3 and 4.

In FIG. 5, numeral 100 represents a control section including CPU, ROM and RAM, numeral 86 represents a switching member, numeral 104 represents a solenoid which drives switching member 86, numeral 101 represents an operation section, numeral 102 represents a sensor which detects the size of sheet, provided on sheet supplying section 6, numeral 103 represents a memory to store the image data.

Based on sheet size information sent from sensor 102 provided on sheet supplying section 6, control section 100 controls the drive of solenoid 104, and further selects either sheet re-supplying route 84 or 85, using switching member 86.

In double-sided image formation, based on sheet size information sent from sensor 102, control section 100 selects sheet re-supplying route 84 or 85, as described above, further, at the terminal stage of double-sided image formation, control section 100 selects shorter re-supplying route 84.

### Embodiment 2

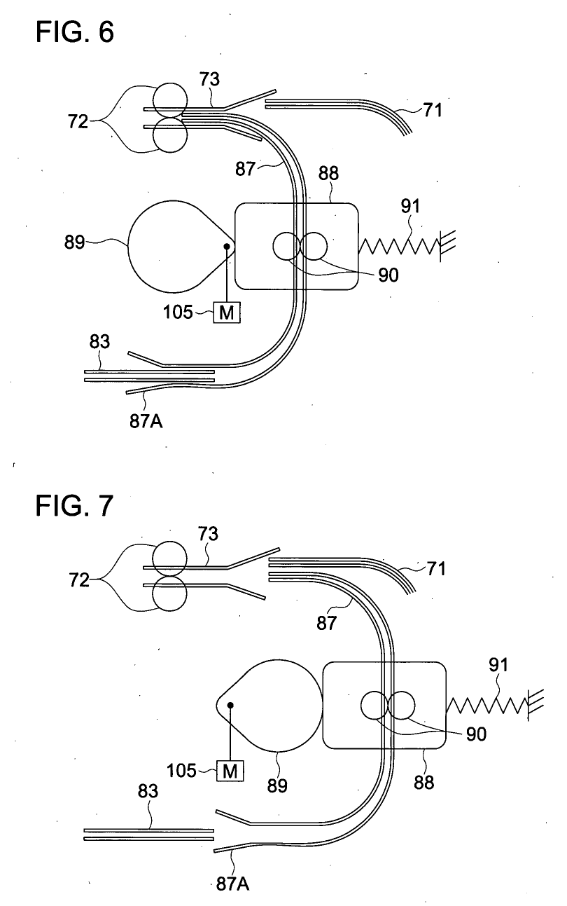

FIGS. 6 and 7 shows embodiment 2 in which the length of a sheet re-supplying route is changeable.

The sheet re-supplying route (being a movable route) is formed of movable paired guide members 87. Guide member 87 includes end section 87A, being a horn aperture to more easily receive the recording sheet from re-supplying route 83, while guide member 73 is also formed as a horn aperture, which is mounted adjacent to paired registration rollers 72, to receive the recording sheet from the sheet re-supplying route.

Both paired guide members 87 and paired conveyance rollers 90 are united and secured by supporting member 88. Supporting member 88, pressed against cam 89, which is a changing member to change the length of sheet re-supplying route, by spring 91. Supporting member 88 changes the position, while following the rotation of cam 89 by spring 91, as shown in FIGS. 6 and 7. The length of the sheet re-supplying route formed of paired guide members 87 is thus changed by the changed rotation of cam 89.

In FIG. 6, paired guide members 87 form the shortest re-supplying route, while in FIG. 7, the same form the longest re-supplying route. By setting paired guide members 87 at more than three positions, the length of the sheet re-supplying route can be set into plural steps. In addition, comparing to embodiment 1 in which the plural re-supplying routes are switched, the length of re-supplying route can be optionally obtained in embodiment 2, which is more preferable.

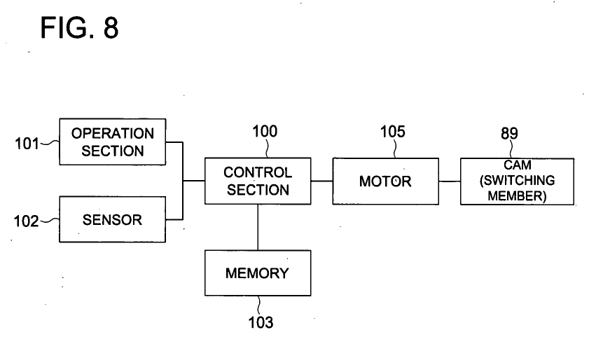

FIG. 8 is a block diagram of the conveyance control system of double-sided image formation, relating to embodiment 2 shown in FIGS. 6 and 7.

The same numbers are applied to sections in FIG. 8 which are the same as those in FIG. 5, and the explanation is neglected. Numeral 89 represents a cam, and numeral 105 represents a motor which drives cam 89.

Control section 100 controls the drive of motor 105, based on sheet size information which is sent from sensor 102 provided on sheet supplying section 6, and changes the length of sheet re-supplying route, using cam 89, as shown in FIGS. 6 and 7.

Further, in double-sided image formation, as described above, based on sheet size information which is sent from sensor 102, control section 100 selects either sheet re-supplying route 84 or 85, still further, at the terminal stage of double-sided image formation, control section 100 employs the shortest re-supplying route shown in FIG. 7.

Based on the present invention, since the productivity for double-sided image formation is increased to 100% or near 100%, double-sided image forming production rate improves.

At the terminal stage of double-sided image forming procedure, reduced is the operational time of double-sided image formation in which recording sheets are supplied only from the circulation conveyance route, which results in increased double-sided image forming efficiency.

What is claimed is:

1. A double-sided image forming apparatus, comprising:
an image forming section;
a sheet supplying section, which supplies a sheet to the image forming section, including
paired registration rollers which convey the sheet supplied from the sheet supplying section to the image forming section;
a circulation conveyance route which conveys the sheet carrying an image formed by the image forming section on a front side, and which flips the sheet and re-supplies the flipped sheet to the image forming section through the paired registration rollers; and
a control section which controls to change a length of the circulation conveyance route, and controls to convey the sheet based on a size of the sheet.

2. The double-sided image forming apparatus of claim 1, wherein the circulation conveyance route includes:
plural re-supplying routes whose lengths are different to each other; and
a switching member which selects the re-supplying routes among the plural re-supplying routes;
wherein the control section controls the switching member to select the re-supplying routes, and controls to convey the sheet through the selected re-supplying routes whose lengths are different to each other.

3. The double-sided image forming apparatus of claim 2, wherein at a terminal stage of double side image formation, on which the sheet is not conveyed from the sheet supplying section, and image formation is conducted on the sheet which is conveyed only through the re-supplying route, the control section controls to convey the sheet through a shortest re-supplying route.

4. The double-sided image forming apparatus of claim 1, wherein the circulation conveyance route includes:
a movable re-supplying route which is formed of a movable guide member; and
a changing member which changes a length of the re-supplying route by changing a position of the guide member;
wherein the control section controls to change the positions of the changing members, and controls to convey the sheet by the re-supplying routes whose lengths are different to each other.

5. The double-sided image forming apparatus of claim 4, wherein at a terminal stage of double side image formation, on which the sheet is not conveyed from the sheet supplying section, and a reverse side image formation is conducted on the sheet which is conveyed only through the re-supplying route, the control section controls to convey the sheet through a shortest re-supplying route.
